(19) United States
(12) Patent Application Publication
(10) Pub. No.: US 2008/0123073 A1
(43) Pub. Date: May 29, 2008

(54) Optical element, exposure apparatus using the same, and device manufacturing method

(75) Inventors: Masayuki Shiraishi, Kumagaya-shi (JP); Katsuhiko Murakami, Sagamihara (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: NIKON CORPORATION

(21) Appl. No.: 11/984,616

(22) Filed: Nov. 20, 2007

Related U.S. Application Data
(60) Provisional application No. 60/935,478, filed on Aug. 15, 2007.

(30) Foreign Application Priority Data
Nov. 27, 2006 (JP) P2006-318441

(51) Int. Cl. G03B 27/54; G02B 5/08

(52) U.S. Cl. 355/67; 359/360

(57) ABSTRACT

There is disclosed an optical element, comprising, a supporting substrate, a multilayer film being supported on the substrate and reflecting extreme ultraviolet light, and an alloy layer provided between the multilayer film and the substrate.

### CROSS-REFERENCE TO RELATED APPLICATIONS

This application is based upon and claims the benefit of priority from Japanese Patent Application No. 2006-318441, filed Nov. 27, 2006, and a non-provisional application No. 60/935,478, filed on Aug. 15, 2007, the entire contents of which are incorporated herein by reference.

### BACKGROUND

1. Field

One Embodiments of the present invention relates to an optical element used for extreme ultraviolet light etc., an exposure apparatus using the same, and a device manufacturing method.

2. Description of the Related Art

In recent years, as the semiconductor integrated circuits have become finer, an exposure technology using extreme ultraviolet light, instead of the conventional ultraviolet light, with a wavelength (11 to 14 nm) shorter than that of the conventional ultraviolet light has been developed in order to improve the resolution of an optical system achieved by the diffraction limit of light. With this technology, the exposure of a pattern size of approximately 5 to 70 nm is expected to be available, however, because the refractive index of a substance in this region is close to one, a transmissive refraction type optical element cannot be used unlike in the past and thus a reflection type optical element is used. Usually, a mask used in an exposure apparatus is also a reflection type optical element in terms of securing the transmissivity and the like. In this case, in order to achieve a high reflectivity in each optical element, it is common to alternately deposit a substance having a high refractive index in the used wavelength region and a substance having a low refractive index, on a substrate, in multiple layers. As the multilayer film having a high reflectivity, a molybdenum (Mo)/silicon (Si) multilayer film is common.

Incidentally, the Mo/Si multilayer film typically has a strong compressive internal stress. Therefore, when the Mo/Si multilayer film is formed on an accurately polished substrate of optical elements, there is a problem that the compressive stress deforms the substrate, causes wavefront aberration in the optical system, and thus deteriorates the optical properties. Then, it has been contemplated that the internal stress of the multilayer film is reduced by providing, in the lower layer of a first Mo/Si multilayer film which is a conventional type multilayer film, a second Mo/Si multilayer film, in which the thickness of Mo or Si differs from that of the first Mo/Si multilayer film (e.g., see WO 2004/109778).

However, if the Mo/Si multilayer film is used as the second layer, a total film thickness increases and a more accurate control of the film thickness distribution is required because the internal stress is small as compared with the value that can be achieved with a monolayer, and there is also a problem that the film deposition process takes time.

In addition, the internal stress in the multilayer film can be also reduced by providing a single layer film of a Mo layer in the lower layer of the multilayer film. However, if the film deposition is carried out in such thickness that reduces the internal stress of the multilayer film, there is a problem that the surface roughness increases due to micro-crystallization, thereby deteriorating the reflectivity of the optical element.

Then, it is an object of the present invention to provide an optical element whose optical properties is improved by reducing the internal stress with a simple method.

It is also an object of the present invention to provide an exposure apparatus that incorporates the above-described optical element as a projection optical system etc. used for extreme ultraviolet light, and a device manufacturing method.

In order to solve the above-described problems, an optical element concerning one embodiment of the present invention comprises (a) a supporting substrate, (b) a multilayer film being supported on the substrate and reflecting extreme ultraviolet light, and (c) an alloy layer being provided between the multilayer film and the substrate and reducing an internal stress of the multilayer film.

In the above-described optical element, the alloy layer is provided between the multilayer film and the substrate, and this alloy layer can achieve various internal stresses by adjusting its component or composition ratio, so that the internal stress of the multilayer film can be canceled out or reduced. For this reason, the deformation of the optical element can be inhibited and high optical properties can be maintained. In this case, because the alloy layer is unlikely to crystallize, the surface roughness thereof can be reduced. Accordingly, the flatness in the surface of the underlayer of the multilayer film is secured, and thereby the reflectivity deterioration of the multilayer film is inhibited, thus maintaining high optical properties. In addition, although the above-described optical element is a reflection type element with a multilayer film and has excellent reflection characteristics with respect to extreme ultraviolet light, the optical element may have reflectiveness with respect to soft-X rays and the like other than the extreme ultraviolet light.

Moreover, according to a specific aspect or form of the present invention, in the optical element the alloy layer has a tensile internal stress. In this case, the compressive internal stress which the multilayer film has can be canceled out or reduced by the tensile internal stress of the alloy layer and thus the deformation of the substrate can be reduced.

An exposure apparatus of one embodiment of the present invention comprises (a) a light source generating extreme ultraviolet light, (b) an illumination optical system introducing extreme ultraviolet light from the light source to a transfer mask, and (c) a projection optical system forming a pattern image of the mask onto a sensitive substrate. Then, in this exposure apparatus, at least any one of the mask, the illumination optical system, and the projection optical system includes the optical element described above.

In the above-described exposure apparatus, by using at least one optical element described above, the deformation of the relevant optical element can be inhibited and the optical properties of the optical element can be made excellent in the apparatus. This allows the resolution of the exposure apparatus to be maintained. It is also possible to inhibit the optical element from gradually deforming and to make the optical element and eventually the exposure apparatus long-lived.

According to a device manufacturing method of one embodiment of the present invention, high performance devices can be manufactured using the above-described exposure apparatus in the manufacturing process.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention. In general, there is provided an comprises (a) a supporting substrate, (b) a multilayer film being supported on the substrate and reflecting extreme ultraviolet light, and (c) an alloy layer being provided between the multilayer film and the substrate and reducing an internal stress of the multilayer film.

FIG. 1 is an exemplary cross sectional view illustrating an optical element concerning a first embodiment.

FIG. 2 is an exemplary cross sectional view illustrating the optical element concerning the first embodiment.

FIG. 3 is an exemplary cross sectional view illustrating an optical element concerning a second embodiment.

FIG. 4 is an exemplary cross sectional view illustrating an exposure apparatus concerning a third embodiment.

FIG. 5 is an exemplary view illustrating a device manufacturing method concerning a fourth embodiment.

### DETAILED DESCRIPTION

Various embodiments according to the invention will be described hereinafter with reference to the accompanying drawings. In general, according to one embodiment of the invention, there is provide an optical element comprising (a) a supporting substrate, (b) a multilayer film being supported on the substrate and reflecting extreme ultraviolet light, and (c) an alloy layer being provided between the multilayer film and the substrate and reducing an internal stress of the multilayer film, an exposure apparatus comprises (a) a light source generating extreme ultraviolet light, (b) an illumination optical system introducing extreme ultraviolet light from the light source to a transfer mask, and (c) a projection optical system forming a pattern image of the mask onto a sensitive substrate, using the above optical element.

### First Embodiment

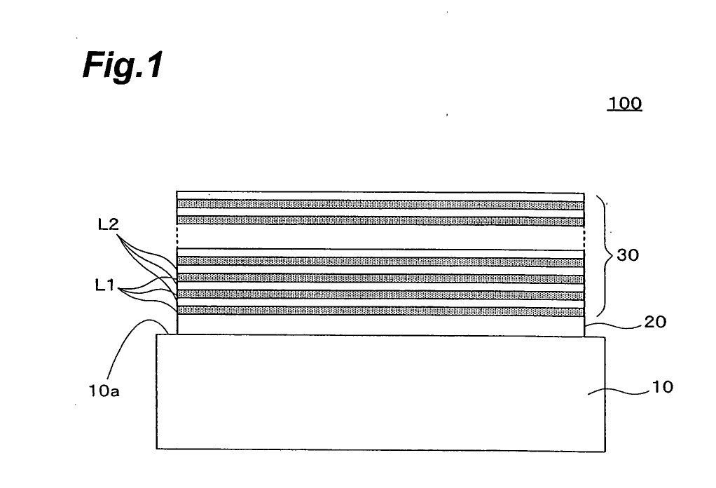

FIG. 1 is a cross sectional view showing the structure of an optical element concerning a first embodiment. An optical element 100 of this embodiment is a plane reflector, for example, which includes a substrate 10 for supporting a multilayer film structure, a multilayer film 30 for reflection, and an alloy layer 20 for stress relief.

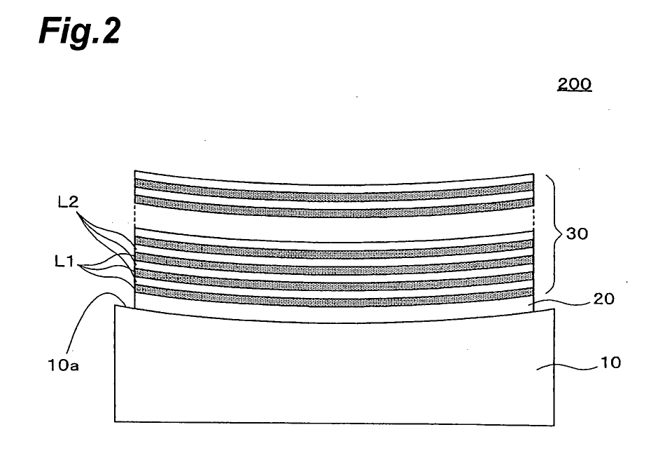

A lower substrate 10 is formed by processing a synthetic quartz glass or a low expansion glass, for example, and an upper surface 10a thereof is polished into a mirror plane with a predetermined accuracy. The upper surface 10a may be a flat surface as illustrated, but may be a concave surface such as an optical element 200 shown in FIG. 2. Moreover, although illustration is omitted, the upper surface 10a may be a convex surface, a multifaceted surface, or other shaped surface depending on the application of the optical element 100.

The upper multilayer film 30 is a several to several hundreds layers of thin film formed by alternately depositing two types of substances, whose refractive indexes differ from each other, on the alloy layer 20. This multilayer film 30 is obtained by depositing multiple substances with a small optical absorption in order to increase the reflectivity of the optical elements 100 and 200, which are reflectors, and the film thickness of each layer is adjusted on the basis of light interference theory so that the phases of the respective reflected waves may align with each other. Namely, the multilayer film 30 is formed by alternately depositing, in a predetermined film thickness, a thin film layer L1 having a relatively large refractive index with respect to the wavelength region of extreme ultraviolet light used in the exposure apparatus and a thin film layer L2 having a relatively small refractive index, on the alloy layer 20 so that the phases of reflected wave may align with each other. This allows the reflectivity of extreme ultraviolet light or the like of a target wavelength to be increased efficiently. In addition, for simplicity of description, the number of deposition layers in the multilayer film 30 is omitted and shown in the view.

Two types of thin film layers L1 and L2 constituting this multilayer film 30 may be a Mo layer and a Si layer, respectively. In addition, the conditions such as the order of depositing the thin film layers L1 and L2, and which thin film layer is to serve as the top layer may be modified suitably depending on the application of the optical elements 100 and 200. Moreover, the material of the thin film layers L1 and L2 is not limited to the combination of Mo and Si. For example, the multilayer film 30 may be also prepared by combining suitably a substance, such as Mo, ruthenium (Ru), or rhodium (Rh), with a substance, such as Si, beryllium (Be), or carbon tetraboride (B₄C).

In addition, a boundary film (not shown) may be further provided between the thin film layer L1 and the thin film layer L2 in the multilayer film 30. Especially when metal, Si or the like is used as the thin film layers L1 and L2 that form the multilayer film 30, the materials for forming each layer will mix with each other in the vicinity of the boundary between the thin film layer L1 and the thin film layer L2, and thus the interface tends to be unclear. This may affect the reflection characteristics, resulting in a decrease in the reflectivity of the optical elements 100 and 200. Then, in order to make the interface clear, a boundary film is further provided between the thin film layer L1 and the thin film layer L2 when forming the multilayer film 30. As the material thereof, B₄C, carbon (C), molybdenum carbide (MoC), molybdenum dioxide (MoO₂), or the like is used, for example. Thus, by making the interface clear, the reflection characteristics of the optical elements 100 and 200 will be improved.

Moreover, in the multilayer film 30, a protective film having an oxidation inhibiting effect or a carbon deposition inhibiting effect may be further provided on the outermost layer of the multilayer film 30.

The alloy layer 20 interposed between the substrate 10 and the multilayer film 30 described above is a thin film composed of an alloy having an internal stress. “Alloy” generally means a material in which at least two metal elements or at least one metal element and at least one non-metal element are mixed as a solid-solution in an atomic level thereof. Beside, since although a single metal always includes any impurity atom, such impurity is not deemed as additive constructing alloy, in the specification, “a material in which at least two elements are mixed as a solid-solution in an atomic level, having a metal characteristic, an element having a maximum rate of the number of atoms thereof in the material and constituting the material is metal element, and the rate of content of an element having secondary large rate in the number of atoms is larger than 1% (the rate of the number of atoms %)” is called as an alloy. Especially, when the rate of content of an element having secondary large rate in the number of atoms is larger than 5%, the characteristic of the material different from that of the single metal is remarkable. Further, when the rate of content of an element having secondary large rate in the number of atoms is larger than 10%, such alloy material may cause the merit of the present invention effectively. More specifically, the alloy layer 20 contains a combination of two or more types selected from the group consisting of Mo, Ru, niobium (Nb), palladium (Pd), and copper (Cu), and is obtained by alloying these. Such alloy layer 20 is structurally easily stabilized. Moreover, when depositing this alloy layer 20, island growth is inhibited and an amorphous layer with a low crystallinity will grow, so that the alloy layer 20 becomes thin but uniform and defect-free, allowing the surface roughness to be reduced. For this reason, a disorder of the structure of the multilayer film 30 is unlikely to occur when depositing the multilayer film 30 on the alloy layer 20, thus enabling to prevent the optical properties from deteriorating.

The above-described alloy layer 20 may be prepared with various film deposition methods, such as vapor deposition and sputtering (including ion beam sputtering, magnetron sputtering, or the like), if a fine film can be made without deteriorating the surface roughness. Moreover, the internal stress of the alloy layer 20 may be set and adjusted depending on the film deposition conditions of the alloy layer 20. In addition, between the alloy layer 20 and the multilayer film 30, an anti-diffusion film that prevents the component of the alloy layer 20 from diffusing into the multilayer film 30 may be also formed.

In this embodiment, the alloy layer 20 has a tensile internal stress, and reduces a compressive internal stress, which the multilayer film 30 has, by applying the tensile stress to the multilayer film 30. The thickness of the alloy layer 20 is adjusted corresponding to a tensile stress required to reduce the compressive internal stress of the multilayer film 30. As a result, the deformation of the optical elements 100 and 200 can be inhibited, thereby making their optical properties excellent.

Hereinafter, a specific example of the optical elements 100 and 200 concerning the first embodiment is described. As the material of the substrate 10, “ULE (Ultra Low Expansion), (brand name)” made by Corning International Corp., which is a low thermal expansion glass, was used. Instead of ULE, other low thermal expansion glass, such as “Zerodur (brand name)” or the like made by Schott AQ may be also used. In order to prevent the reflectivity deterioration due to the surface roughness of the substrate 10, the surface of the substrate 10 is polished into a surface roughness equal to or less than 0.2 nm RMS.

On the substrate 10 as described above, a MoRu alloy was deposited to form the alloy layer 20 by sputtering. The thickness of the alloy layer 20 was set to 56 nm.

In addition, according to this embodiment, although an example using a monolayer film of MoRu as the alloy layer 20 has been described, other Mo-based alloy layer 20 may be formed using MoNb, MoPd, MoCu, or the like other than this MoRu. As such an alloy layer 20, a monolayer film of MoNb, MoPd, and MoCu was deposited respectively, and a continuous and uniform thin film was obtained as in the above-described example of MoRu. Which one of a compressive internal stress or a tensile internal stress the alloy monolayer film will have may vary depending on the film deposition method. Then, such an elemental metal that will have a tensile internal stress when individually deposited is selected and combined to thereby obtain a target tensile internal stress. Moreover, for the alloy layer 20, two layers, or three or more layers of two or more types of alloys may be deposited, as needed, if to the extent that the compressive internal stress of the multilayer film 30 is reduced and the surface roughness of the alloy layer 20 is not affected. However, the alloy layer is made one layer so that the alloy layer 20 can be formed with a simple step.

On the alloy layer 20 as described above, the Mo/Si-based multilayer film 30 was deposited by sputtering. In this case, the thin film layer L1 is a Mo layer, in which the difference from the refractive index of one is large, and the thickness thereof is set to 2.3 nm.

Moreover, the thin film layer L2 is a Si layer in which the difference from the refractive index of one is small, and the thickness thereof is set to 4.6 nm. Accordingly, the thickness of one cycle (periodic length) of the multilayer film 30 is approximately 7 nm. When forming the multilayer film 30, starting with the Mo thin film layer L1, the Si thin film layer L2 and the Mo thin film layer L1 were alternately deposited to complete the multilayer film 30 comprised of 40 layer-pairs. A total film thickness of the multilayer film 30 is approximately 280 nm.

In addition, the above-described MoRu alloy layer 20 and Mo/Si-based multilayer film 30 were continuously deposited within the same film deposition equipment without breaking vacuum. During film deposition, the substrate 10 was water-cooled to maintain room temperature.

Here, the internal stress of the optical elements 100 and 200 of the embodiment is considered. For the sign of stress (Pa), a negative value indicates a compressive stress and a positive value indicates a tensile stress. Moreover, a force applied on the substrate is accounted for by a total stress that is a product of the film thickness and the stress, because the stress varies depending on the film thickness. Namely, a force per unit length applied on the cross section of the multilayer film 30 is considered.

According to this embodiment, the Mo/Si-based multilayer film 30 has a compressive internal stress of approximately niobium −400 MPa at a total film thickness of approximately 280 nm. At this time, this Mo/Si-based multilayer film 30 has a total stress of −112 N/m.

Moreover, the MoRu alloy layer 20 has a tensile internal stress of approximately +2 GPa at a film thickness of 56 nm. At this time, the MoRu alloy layer 20 has a total stress of +112 N/m in the tensile direction. Accordingly, the compressive internal stress which the Mo/Si-based multilayer film 30 has is canceled out by the tensile internal stress which the MoRu alloy layer 20 has, and thus the force applied on the substrate 10 can be reduced. However, the internal stress varies depending on the material, film thickness, film deposition method, and the like, and the internal stress may not be completely canceled out with the material, film thickness, film deposition method, and the like as selected above. In this case, the material, film thickness, film deposition method, and the like may be modified suitably so as to cancel out the internal stress.

Moreover, according to this embodiment, the surface roughness of the MoRu alloy layer 20 with a thickness of 56 nm is 0.2 to 0.3 nm RMS, and the reflectivity deterioration due to the surface roughness can be reduced even if the Mo/Si-based multilayer film 30 is formed on top of this alloy layer.

Here, in a comparative example temporarily using a monolayer film of a single component of Mo instead of the alloy layer 20, the Mo monolayer film has a tensile internal stress at a film thickness of 56 nm and the stress thereof is on the order of approximately +2 GPa as in the above-described alloy layer 20. However, for the Mo monolayer film of 56 nm, the surface roughness thereof increases due to micro-crystallization of Mo and grows as large as 0.8 nm RMS. Since the substrate 10 is usually polished to 0.2 nm RMS or less, if the surface roughness of the Mo monolayer film becomes as large as 0.8 nm RMS, then the reflectivity of the Mo/Si-based multilayer film 30 to be deposited thereon will decrease significantly.

On the other hand, in case of the comparative example that temporarily uses, instead of the alloy layer 20, the Mo/Si-based multilayer film, in which the thickness ratio of the Mo layer differs, such a multilayer film will have a tensile internal stress due to the adjustment of the thickness ratio of the Mo layer with respect to the thickness of the Si layer, and the tensile internal stress is about +200 MPa at a film thickness of 560 nm. However, since the thickness of the whole Mo/Si-based multilayer film will be three times the thickness of the original Mo/Si-based multilayer film 30, the film thickness distribution needs to be controlled extremely accurately, and thus the process will be complicated.

### Second Embodiment

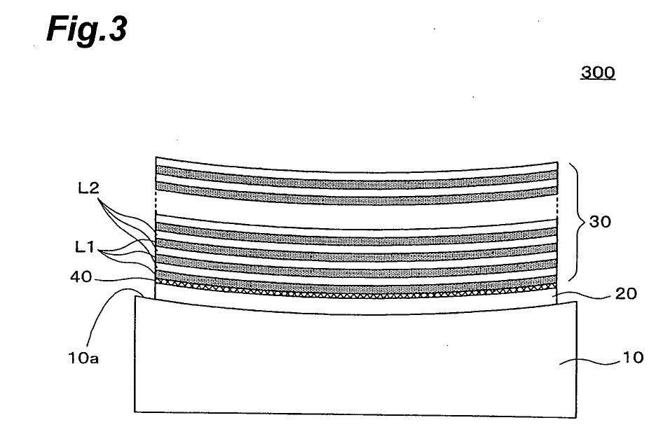

FIG. 3 is a cross sectional view of the structure of an optical element concerning a second embodiment. An optical element 300 of this embodiment is a modification of the optical elements 100 and 200 of the first embodiment shown in FIGS. 1 and 2, and here the same portion is given the same reference numeral to omit the duplicated description. Moreover, the portion not described in particular is the same as the one in the first embodiment.

In this optical element 300, a resin layer 40 is provided between the alloy layer 20 and the multilayer film 30. This makes the surface of the alloy layer, which is an underlayer of the multilayer film 30, smoother so as not to affect the surface roughness when depositing the multilayer film 30. In addition, the thickness of the resin layer is determined suitably depending on desired reflection characteristics with respect to the optical element 300.

A polyimide resin can be used as the material constituting the resin layer 40. Specifically, above the alloy layer, a polyimide solution is spin coated, and is cured to form the thin film. The film thickness is about 50 to 100 nm. The polyimide resin is excellent in heat resistance and will not produce effects, such as deterioration of the resin layer 40, when depositing the multilayer film 30. For this reason, the resin layer 40 made of a polyimide resin is effective in further smoothing the uppermost surface of the alloy layer 20, and is excellent as the underlayer when depositing the multilayer film 30.

In addition, for the material of the resin layer 40, not only a polyimide resin but an organic material and the like having the similar function may be used.

### Third Embodiment

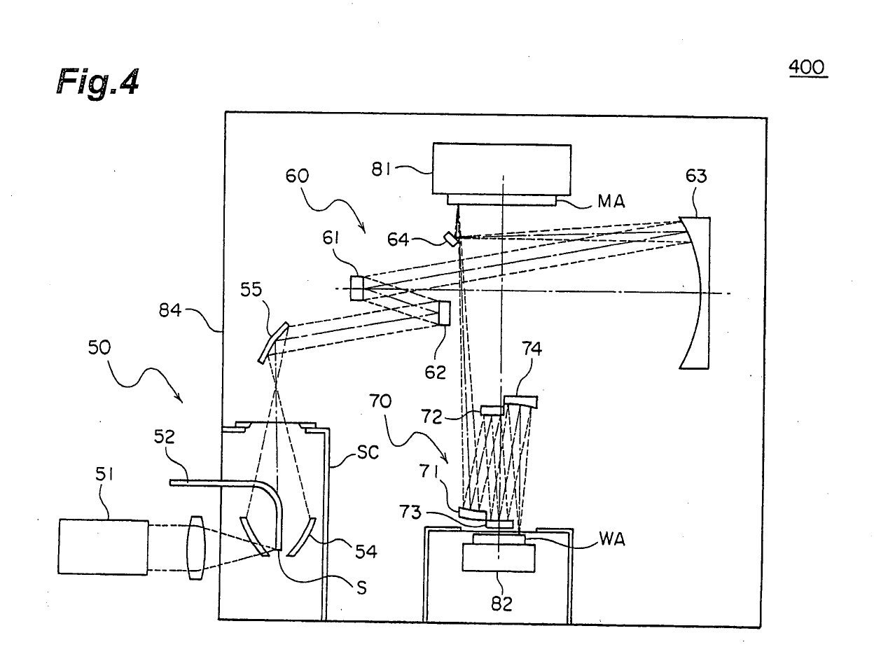

FIG. 4 is a view for illustrating the structure of an exposure apparatus 400 concerning a third embodiment, which incorporates the optical elements 100, 200, and 300 of the first and second embodiments as the optical component.

As shown in FIG. 4, this exposure apparatus 400 includes; as the optical system, a light source device 50 for generating extreme ultraviolet light (with a wavelength of 11 to 14 nm); an illumination optical system 60 that illuminates a mask MA with illumination light of extreme ultraviolet light; and a projection optical system 70 that transfers a pattern image of the mask MA to a wafer WA that is a sensitive substrate, and further includes; as a machinery mechanism, a mask stage 81 for supporting the mask MA; and a wafer stage 82 for supporting the wafer WA.

The light source device 50 includes a laser light source 51 generating a laser beam for plasma excitation, and a tube 52 supplying a gas such as xenon, which is a target material, into an enclosure SC. Moreover, a condenser 54 and a collimator mirror 55 are attached to this light source device 50. By focusing the laser beam from the laser light source 51 onto the xenon emitted from a tip of the tube 52, the target material in this portion is turned into a plasma state to generate extreme ultraviolet light. The condenser 54 focuses the extreme ultraviolet light generated at the tip S of the tube 52. The extreme ultraviolet light via the condenser 54 is emitted outside the enclosure SC while being focused, and is incident upon the collimator mirror 55. In addition, in place of the source light from the laser plasma type light source device 50 as described above, a radiation light or the like from a discharge plasma light source or a synchrotron radiation light source may be used.

The illumination optical system 60 includes reflection type optical integrators 61 and 62, a condenser mirror 63, a bent mirror 64, and the like. The source light from the light source device 50 is focused by the condenser mirror 63 while being equalized by the optical integrators 61 and 62, as the illumination light, and is entered into a predetermined region (e.g., belt-like region) on the mask MA via the bent mirror 64. Accordingly, a predetermined region on the mask MA can be uniformly illuminated with extreme ultraviolet light of an appropriate wavelength.

Note that there is no substance having a sufficient transmissivity in the wavelength region of extreme ultraviolet light, and thus instead of a transmission type mask, a reflection type mask is used for the mask MA.

The projection optical system 70 is a reduction projection system comprised of multiple mirrors 71, 72, 73, and 74. A circuit pattern that is a pattern image formed on the mask MA is imaged onto the wafer WA, where resist is applied, by the projection optical system 70, and is transferred to this resist. In this case, a region where the circuit pattern is projected all together is a straight shaped or arc-shaped slit region, and for example, a circuit pattern in a rectangular region formed on the mask MA can be transferred to a square region on the wafer WA without waste by scan exposure that synchronously moves the mask MA and the wafer WA.

Among the above-described light source device 50, a portion disposed on an optical path of extreme ultraviolet light, the illumination optical system 60, and the projection optical system 70 are disposed within a vacuum chamber 84, thus preventing an attenuation of the exposing light. Namely, the extreme ultraviolet light is absorbed and attenuated by the atmosphere, however the entire apparatus is sealed from the outside by the vacuum chamber 84, and the optical path of extreme ultraviolet light is maintained at a predetermined degree of vacuum (e.g., no more than 1.3×10⁻³ Pa), thereby preventing an attenuation of the extreme ultraviolet light, i.e., a decrease in brightness of the transfer image and a decrease in contrast.

In the above-described exposure apparatus 400, as the optical elements 54, 55, 61, 62, 63, 64, 71, 72, 73, and 74 disposed on the optical path of extreme ultraviolet light and the mask MA, the optical elements 100, 200, and 300 illustrated in FIG. 1 and the like are used. In this case, the shape of the optical surface of the optical elements 100, 200, and 300 is not limited to a flat surface or a concave surface, and the shape thereof is suitably adjusted to a convex surface, a multifaceted surface, and the like depending on the place where the optical elements are incorporated.

Hereinafter, the operation of the exposure apparatus 400 shown in FIG. 4 is described. In this exposure apparatus 400, the mask MA is irradiated with illumination light from the illumination optical system 60, whereby a pattern image of the mask MA is projected onto the wafer WA by the projection optical system 70. Thus, the pattern image of the mask MA is transferred to the wafer WA.

In the exposure apparatus 400 described above, the optical elements 54, 55, 61, 62, 63, 64, 71, 72, 73, and 74 and the mask MA, which have a high reflectivity and are controlled accurately, are used and have a high resolution due to the prevention of deformation, thus allowing for accurate exposure. Moreover, it is possible to inhibit the optical elements 54, 55, 61, 62, 63, 64, 71, 72, 73, and 74 and mask MA from gradually deforming with use, and it is also possible to maintain the optical property of the optical elements over a long time period. Thus, the resolution of the exposure apparatus 400 can be maintained and accordingly the life span of the exposure apparatus 400 can be extended.

### Fourth Embodiment

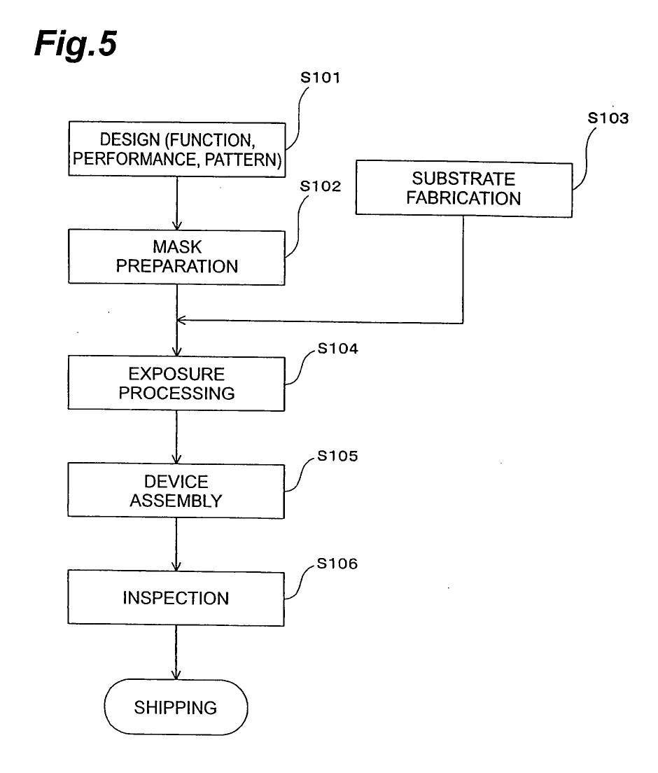

The foregoing is the description of the exposure apparatus 400 and the exposure method using the same, and the use of such an exposure apparatus 400 allows providing a device manufacturing method for manufacturing semiconductor devices and other micro devices in a high degree of integration. Specifically, as shown in FIG. 5, the micro device is manufactured through a process of designing the function, performance, and the like of the micro device (S101), a process of preparing the mask MA based on this design step (S102), a process of preparing a substrate, i.e., the wafer WA, which is a base material of the device (S103), an exposure process to expose a pattern of the mask MA to the wafer WA using the exposure apparatus 400 of the above-described embodiment (S104), a device assembly process to complete elements while repeating a series of exposure, etching, and the like (S105), and a process of inspecting the device after assembly (S106). In addition, the device assembly process (S105) typically includes a dicing process, a bonding process, a packaging process, and the like.

As described above, the present invention has been described based on the embodiments, but the present invention is not limited to the above-described embodiments. For example, in the above-described embodiments, a case has been mainly described, in which the multilayer film 30 has a compressive internal stress, however, in the case where the multilayer film 30 has a tensile internal stress, a material with which the alloy layer 20 has a compressive internal stress may be selected to form the multilayer film 30.

Moreover, in the above-described embodiments, the exposure apparatus 400 using extreme ultraviolet light as the exposing light has been described, however, also in an exposure apparatus using soft-X rays or the like other than extreme ultraviolet light as the exposing light, optical elements similar to the optical elements 100, 200, and 300 as shown in FIG. 1 and the like, can be incorporated and thus the deterioration of the optical property of the optical element can be inhibited.

Moreover, other than the exposure apparatus, various optical instruments including soft-X ray optical instruments, such as a soft-X ray microscope and a soft-X ray analysis device, for example, may incorporate the optical elements 100, 200, and 300 shown in FIG. 1 and the like. The optical elements 100, 200, and 300 that are incorporated so as to adapt to such soft-X ray optical instruments also can inhibit deterioration of the optical property of the optical elements 100, 200, and 300 in the long term as in the above-described embodiments.

What is claimed is:

1. An optical element, comprising:
a supporting substrate;
a multilayer film being supported on the substrate and reflecting extreme ultraviolet light; and
an alloy layer provided between the multilayer film and the substrate.

2. The optical element according to claim 1, wherein the alloy layer applies a tensile stress to the multilayer film.

3. The optical element according to claim 1, wherein the alloy layer is composed of an alloy single layer film.

4. The optical element according to claim 2, wherein the alloy layer is composed of an alloy single layer film.

5. The optical element according to claim 1, wherein the multilayer film is formed by alternately depositing on the substrate a first layer comprised of a substance in which a difference between the refractive index thereof and the refractive index of vacuum in an extreme ultraviolet region is large, and a second layer comprised of a substance in which the difference is small.

6. The optical element according to claim 2, wherein the multilayer film is formed by alternately depositing on the substrate a first layer comprised of a substance in which a difference between the refractive index thereof and the refractive index of vacuum in an extreme ultraviolet region is large, and a second layer comprised of a substance in which the difference is small.

7. The optical element according to claim 3, wherein the multilayer film is formed by alternately depositing on the substrate a first layer comprised of a substance in which a difference between the refractive index thereof and the refractive index of vacuum in an extreme ultraviolet region is large, and a second layer comprised of a substance in which the difference is small.

8. The optical element according to claim 1, wherein the alloy layer is composed of a molybdenum-based alloy, and contains at least one or more of ruthenium, niobium, palladium, and copper, as an additive.

9. The optical element according to claim 2, wherein the alloy layer is composed of a molybdenum-based alloy, and contains at least one or more of ruthenium, niobium, palladium, and copper, as an additive.

10. The optical element according to claim 3, wherein the alloy layer is composed of a molybdenum-based alloy, and contains at least one or more of ruthenium, niobium, palladium, and copper, as an additive.

11. The optical element according to claim 1, wherein the alloy layer is an alloy composed of a combination of two or more types selected from the group consisting of molybdenum, ruthenium, niobium, palladium, and copper.

12. The optical element according to claim 2, wherein the alloy layer is an alloy composed of a combination of two or more types selected from the group consisting of molybdenum, ruthenium, niobium, palladium, and copper.

13. The optical element according to claim 3, wherein the alloy-layer is an alloy composed of a combination of two or more types selected from the group consisting of molybdenum, ruthenium, niobium, palladium, and copper.

14. The optical element according to claim 1, comprising a resin layer between the alloy layer and the multilayer film.

15. The optical element according to claim 2, comprising a resin layer between the alloy layer and the multilayer film.

16. The optical element according to claim 3, comprising a resin layer between the alloy layer and the multilayer film.

17. The optical element according to claim 14, wherein the resin layer is formed of a polyimide resin.

18. The optical element according to claim 15, wherein the resin layer is formed of a polyimide resin.

19. The optical element according to claim 16, wherein the resin layer is formed of a polyimide resin.

20. An exposure apparatus, comprising:
a light source generating extreme ultraviolet light;
an illumination optical system introducing extreme ultraviolet light from the light source to a transfer mask; and
a projection optical system forming a pattern image of the mask onto a sensitive substrate,
wherein at least any one of the mask, the illumination optical system, and the projection optical system includes an optical element according to claim 1.

21. An exposure apparatus, comprising:
a light source generating extreme ultraviolet light;
an illumination optical system introducing extreme ultraviolet light from the light source to a transfer mask; and
a projection optical system forming a pattern image of the mask onto a sensitive substrate,
wherein at least any one of the mask, the illumination optical system, and the projection optical system includes an optical element according to claim 2.

22. An exposure apparatus, comprising:
a light source generating extreme ultraviolet light;
an illumination optical system introducing extreme ultraviolet light from the light source to a transfer mask; and
a projection optical system forming a pattern image of the mask onto a sensitive substrate,
wherein at least any one of the mask, the illumination optical system, and the projection optical system includes an optical element according to claim 3.

23. A device manufacturing method using an exposure apparatus according to claim 20.

24. A device manufacturing method using an exposure apparatus according to claim 21.

25. A device manufacturing method using an exposure apparatus according to claim 22.
